(19) United States
(12) Patent Application Publication
(10) Pub. No.: US 2003/0044025 A1
(43) Pub. Date: Mar. 6, 2003

(54) Circuit and method for acoustic source directional pattern determination utilizing two microphones

(75) Inventors: Jing Zheng Ouyang, San Jose, CA (US); Nan Sheng Lin, Fremont, CA (US)

Correspondence Address: TIMOTHY P. O'HAGAN, 8710 KILKENNY CT, FORT MYERS, FL, 33912, US

(73) Assignee: Innomedia Pte Ltd., The Alfa (SG)

(21) Appl. No.: 09/941,488

(22) Filed: Aug. 29, 2001

(51) Int. Cl. H04B 15/00; H04R 3/00

(52) U.S. Cl. 381/92; 381/93

(57) ABSTRACT

A microphone for a full duplex speaker phone comprises a loudspeaker, a uni-directional microphone, a omni-directional microphone, and a background noise suppression circuit. The uni-directional microphone is a directional microphone such that the intensity of an acoustic source detected at the uni-directional microphone is dependent on the angular direction of the acoustic source relative to a reference direction. The omni-directional microphone is a non-directional microphone such that the intensity of the acoustic source detected at the omni-directional microphone is substantially independent of the angular direction of the acoustic source relative to the reference direction. The background noise suppression circuit determines the direction of the acoustic source by calculating a quotient between a signal strength of the acoustic source as detected by the two microphones and provides for suppressing an acoustic source that is not within a threshold angle of the reference angle.

### TECHNICAL FIELD

The present invention generally relates to a microphone circuit for speaker phone telephone systems, and more particularly to circuits and methods for operating a full duplex speaker phone and suppressing acoustic feed back from a loudspeaker to a microphone.

### BACKGROUND OF THE INVENTION

A speaker phone utilizes a loudspeaker and a microphone to enable an operator to participate in a telephone session in a hands free environment. Because the loudspeaker and the microphone are in close proximity, and often located within the same small desk top speaker phone unit, the acoustic output of the loudspeaker may be detected by the microphone and transmitted back over the telephone line. This acoustic feedback typically results in a loud howling noise.

One method of preventing acoustic feedback is to activate only the speaker or only the microphone at any one time. This type of a system is referred to as a half duplex speaker phone. A monitoring circuit monitors the input of the microphone and when the input us above a predetermined threshold (indicating that the operator is speaking), the loudspeaker is deactivated and the microphone is activated to transmit the operator's voice over the telephone line. Alternatively, when the microphone input is below the threshold, the microphone is deactivated and the loudspeaker is active so that the operator can hear the other parties speaking.

Half duplex speaker phones do not suffer acoustic feedback howling because the output of the loudspeaker will never be retransmitted over the telephone line because the loudspeaker and the microphone are never active at the same time.

However, the primary problem associated with half duplex systems is that only one of the two call participants can speak at any particular time. Further, portions of words may be lost due to the monitoring circuit requiring time to switch between the microphone active state and the loudspeaker active state. In a telephone conversation wherein both parties are using half duplex speakerphones, a significant portion of the conversation may be lost as the two parties each speak and interrupt each other.

In a full duplex speaker phone, both the loudspeaker and the microphone are active at the same time. As such, portions of words are not lost as the two operators each speak and interrupt each other. To eliminate acoustic feedback in a full duplex speaker phone, complex echo cancellation circuits are used to filter out the portion of the microphone input signal that represents acoustic feedback from the loudspeaker. Such noise cancellation circuits are typically implemented using digital signal processing to achieve the speed necessary to accommodate a telephone conversation in real time. The complexity of the circuits and the required speed needed to make such circuits effective also makes such digital signal processors quite expensive.

What is needed is a device and method for suppressing acoustic feedback from a loudspeaker into a microphone that is useful in a full duplex speaker phone, but does not suffer the disadvantages of known feedback suppression systems.

### SUMMARY OF THE INVENTION

A first aspect of the present invention is to provide a circuit for determining the angular direction of an acoustic source relative to a reference direction. The circuit may comprise a uni-directional microphone providing a uni-directional output signal representing the acoustic source. The unidirectional output signal may have a signal strength characteristic that is a function of the angular position of the acoustic source relative to the reference direction. An omni-directional microphone may provide an omni-directional output signal representing the acoustic source. The omni-directional output signal may have a signal strength characteristic that is substantially independent of the angular position of the acoustic source relative to the reference direction. A directional calculation circuit may determine the angular position of the acoustic source relative to the reference direction utilizing the difference between the signal strength characteristic of the uni-directional output signal and the signal strength characteristic of the omni-directional output signal.

The uni-directional microphone may be located in close proximity to the omni-directional microphone whereby both the uni-directional microphone and the omni-directional microphone are approximately the same distance from the acoustic source. And, both the signal strength characteristic of the uni-directional output signal and the signal strength characteristic of the omni-directional output signal may further be a function of the loudness of the acoustic source and the distance between the acoustic source and each of the uni-directional microphone and the omni-directional microphone.

The directional calculation circuit may calculate a quotient between the signal strength characteristic of the uni-directional output signal and the signal strength characteristic of the omni-directional output signal to determined the angular position of the acoustic source relative to the reference signal.

A second aspect of the present invention is to provide a microphone assembly comprising a uni-directional microphone, an omni-directional microphone, and a background noise suppression circuit. The uni-directional microphone may receive acoustic input from an acoustic source and generate a uni-directional output signal. The uni-directional output signal may have a signal strength characteristic that is a function of the angular direction of the acoustic source relative to a reference direction and the function may have a maxima when the acoustic source is located at the reference direction.

The omni-directional microphone may receive acoustic input from the acoustic source and generate an omni-directional output signal. The omni-directional output signal may have a signal strength characteristic that is substantially independent of the angular direction of the acoustic source relative to the reference direction.

The background noise suppression circuit may receive the uni-directional output signal and the omni-directional output signal and generate a microphone output signal. The background noise suppression circuit may comprise a directional calculation circuit for determining a difference between the signal strength characteristic of the uni-directional output signal and the signal strength characteristic of the omni-directional output signal and may comprise a gain control circuit for suppressing the microphone output signal if the difference between the signal strength characteristic of the uni-directional output signal and the signal strength characteristic of the omni-directional output signal is not within a predetermined parameter.

The uni-directional microphone may be located in close proximity to the omni-directional microphone whereby both the uni-directional microphone and the omni-directional microphone are approximately the same distance from the acoustic source. And, both the signal strength characteristic of the uni-directional output signal and the signal strength characteristic of the omni-directional output signal may further be a function of the loudness of the acoustic source and the distance between the acoustic source and each of the uni-directional microphone and the omni-directional microphone.

The function of determining a difference between the signal strength characteristic of the uni-directional output signal and the signal strength characteristic of the omni-directional output signal may include calculating a quotient between the signal strength characteristic of the uni-directional output signal and the signal strength characteristic of the omni-directional output signal. And, function of suppressing the microphone output signal if the difference between the signal strength characteristic of the uni-directional output signal and the signal strength characteristic of the omni-directional output signal is not within a predetermined parameter may include suppressing the microphone output signal if the quotient is not within a threshold value of unity.

A third aspect of the present invention is to provide a full duplex speaker phone. The full duplex speaker phone may comprise a uni-directional microphone for receiving acoustic input from an acoustic source and for generating a uni-directional output signal. Again, the uni-directional output signal may have a signal strength characteristic that is a function of the angular direction of the acoustic source relative to a reference direction, the function having a maxima when the acoustic source is located at the reference direction. The full duplex speaker phone also may comprise an omni-directional microphone for receiving acoustic input from the acoustic source and for generating a omni-directional output signal. Again, the omni-directional output signal may have a signal strength characteristic that is substantially independent of the angular direction of the acoustic source relative to the reference direction;

A background noise suppression circuit may receive the uni-directional output signal and the omni-directional output signal and generate a microphone output signal. The background noise suppression circuit may comprise a directional calculation circuit for determining a difference between the signal strength characteristic of the uni-directional output signal and the signal strength characteristic of the omni-directional output signal and may comprise a gain control circuit for suppressing the microphone output signal if the difference between the signal strength characteristic of the uni-directional output signal and the signal strength characteristic of the omni-directional output signal is not within a predetermined parameter.

A telephone circuit may transmit a representation of the microphone output signal to a remote telephone device and receive an inbound audio signal from the remote telephone device and a loudspeaker may be coupled to the telephone circuit and may generate an acoustic signal representing the inbound audio signal received from the remote telephone device. The loudspeaker being located approximately 180 degrees from the reference direction. The uni-directional microphone may be located in close proximity to the omni-directional microphone whereby both the uni-directional microphone and the omni-directional microphone are approximately the same distance from the acoustic source. And, both the signal strength characteristic of the uni-directional output signal and the signal strength characteristic of the omni-directional output signal may further be a function of the loudness of the acoustic source and the distance between the acoustic source and each of the uni-directional microphone and the omni-directional microphone.

The function of determining a difference between the signal strength characteristic of the uni-directional output signal and the signal strength characteristic of the omni-directional output signal may include calculating a quotient between the signal strength characteristic of the uni-directional output signal and the signal strength characteristic of the omni-directional output signal. And, function of suppressing the microphone output signal if the difference between the signal strength characteristic of the uni-directional output signal and the signal strength characteristic of the omni-directional output signal is not within a predetermined parameter may include suppressing the microphone output signal if the quotient is not within a threshold value of unity.

The full duplex speaker phone may include a housing configured as a desk top telephone. The uni-directional microphone and the omni-directional microphone may be located near the front side of the housing, the loudspeaker may be located near a back side of the housing, and the reference may be a direction generally extending from the front of the housing.

The full duplex speaker phone may include a housing configured as a note book computer. The uni-directional microphone and the omni-directional microphone may be located near a front side of a base housing portion of the note book computer and the loudspeaker may be located in a base housing portion of the note book computer behind the uni-directional microphone and the omni-directional microphone.

A fourth aspect of the present invention is to provide a method for determining the angular direction of an acoustic source relative to a reference direction. The method may comprise: a) detecting the acoustic source at a uni-directional microphone and providing a uni-directional output signal representing the intensity of the acoustic source, the distance of the acoustic source from the uni-directional microphone, and the angular direction of the acoustic source relative to a reference direction from the uni-directional microphone; b) detecting the acoustic source at a omni-directional microphone and providing a omni-directional output signal representing the intensity of the acoustic source and the distance of the acoustic source from the omni-directional microphone; and c) calculating the angular direction of the acoustic source relative to the reference direction by comparing the uni-directional output signal to the omni-directional output signal.

The step of calculating the angular direction of the acoustic source relative to the reference direction may include calculating the quotient between a signal strength characteristic of the uni-directional output signal and a signal strength characteristic of the omni-directional output signal.

The step of detecting the acoustic source at the uni-directional microphone may be performed in close proximity to the step of detecting the acoustic source at the omni-directional microphone whereby both steps are performed at approximately the same distance from the acoustic source.

For a better understanding of the present invention, together with other and further aspects thereof, reference is made to the following description, taken in conjunction with the accompanying drawings, and its scope will be pointed out in the appended clams.

### BRIEF DESCRIPTION OF THE DRAWINGS

FIG. 1 is a block diagram of a microphone circuit in accordance with one embodiment of this invention;

FIG. 2 is a chart showing signal strength from a uni-directional microphone and from an omni-directional microphone in accordance with one embodiment of this invention;

FIG. 3 is a perspective view of a full duplex speaker phone in accordance with one embodiment of this invention;

FIG. 4 is a block diagram of a full duplex speaker phone in accordance with one embodiment of this invention;

FIG. 5 is a perspective view of a speaker phone equipped notebook computer in accordance with one embodiment of this invention; and

FIG. 6 is a perspective view of a microphone assembly in accordance with one embodiment of this invention.

### DESCRIPTION OF THE PREFERRED EMBODIMENTS

The present invention will now be described in detail with reference to the drawings. In the drawings, like reference numerals are used to refer to like elements throughout.

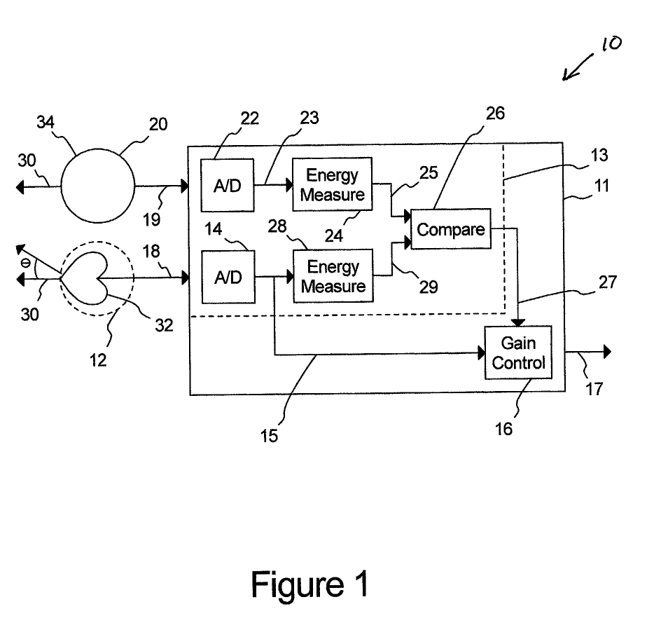

FIG. 1 shows a microphone circuit 10 which provides for a gain adjustment that is dependent on the angular direction of an acoustic source (not shown) relative to a reference direction 30.

The microphone circuit 10 includes a uni-directional microphone 12, an omni-directional microphone 20, and a background noise suppression circuit 11.

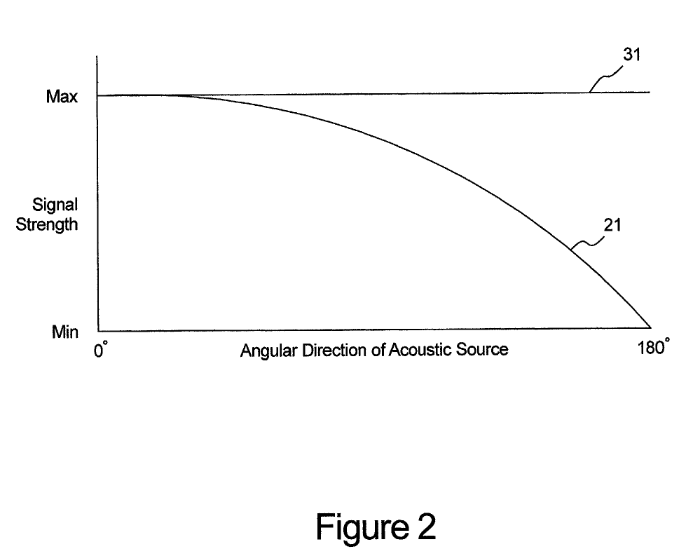

The uni-directional microphone 12 may be a first order gradient (FOG) microphone with a cardoid polar response pattern 32 with the major lobe of the cardoid pattern 32 centered about the reference direction 30. The cardoid polar response pattern 32, indicates the sensitivity of the microphone 12 to an acoustic source at various angular directions (θ) relative to the reference direction 30. The directional sensitivity D(θ) is defined by 1+Cos(θ)/2. In theory, an acoustic source located at the reference direction 30 will be detected with a maximum sensitivity while an acoustic source located 180° away from the reference direction 30 is in a null and will not be detectable. Furthermore, an acoustic source located within approximately 30° of the reference direction 30 will be detected with less than 10% loss in directional sensitivity. Therefore, referring briefly to FIG. 2 in conjunction with FIG. 1, a uni-directional output signal 18 from the uni-directional microphone 12 will have a uni-directional signal strength characteristic 21 that is a function of the angular direction of the acoustic source relative to the reference direction 30. More specifically, the uni-directional signal strength characteristic 21 will be a function of the loudness of the acoustic source, the distance between the acoustic source and the uni-directional microphone 12, and the angular direction of the acoustic source relative to the reference direction 30.

It should be appreciated that the cardoid polar response pattern is dependent on the density of the air, the acoustic wave velocity, and other factors. Therefore, a true cardoid with a perfect null at 180° from the reference direction 30 likely will not exist. As such, an acoustic source at 180° from the reference direction 30 will be detected but at a lower intensity than an acoustic source in the reference direction 30.

The omni-directional microphone 20 is located in close physical proximity to the uni-directional microphone 12 such that an acoustic source (not shown) is approximately equal distance from both the omni-directional microphone 20 and the uni-directional microphone 12. The omni-directional microphone 20 has an omni-directional polar response pattern 34 which indicates that its sensitivity to sound is independent of the angular direction of the acoustic source relative to the reference direction 30. Therefore, referring briefly to FIG. 2 in conjunction with FIG. 1, an omni-directional output signal 19 from the omni-directional microphone 20 will have an omni-directional signal strength characteristic 23 that is substantially independent of the angular direction of the acoustic source relative to the reference direction 30. More specifically, the omni-directional signal strength characteristic 23 will be a function of the loudness of the acoustic source and the distance between the acoustic source and the omni-directional microphone 20, but will not be a material function of the angular direction of the acoustic source relative to the reference direction 30.

Each of the uni-directional output signal 18 and the omni-directional output signal 19 are coupled to the background noise suppression circuit 11. More specifically, the uni-directional output signal 18 is coupled to an input of a first analog to digital (A/D) converter 14. In the exemplary embodiment, the first A/D converter 14 is an 10-bit A/D converter clocked at a sampling frequency of 8 KHz. However, A/D converters with other sampling resolutions and sampling rates sufficient to provide a digital audio signal representing an operators voice may be used. Similarly, the omni-directional output signal 18 is coupled to an input of a second A/D converter 22. The second A/D converter 22 may also be an 10-bit A/D converter clocked at a sampling frequency of 8 KHz or other A/D converter with an applicable sampling resolution and sampling rate that matches that of the first A/D converter 14.

The first digital audio signal 15 may be coupled to an input of a first energy measuring circuit 28. The first energy measuring circuit 28 provides a first measurement signal 29 representing the intensity of the acoustic source as detected by the uni-directional microphone 12. More specifically, the first energy measuring circuit 28 may integrate the magnitude of first digital audio signal 15 and the first energy measurement signal 29 may be an 8 KHz signal with each sample value representing the average magnitude of each sample of the first digital audio signal 15 over a previous time interval on the order of 0.1 seconds.

Similarly, the second digital audio signal 23 may be coupled to an input of a second energy measuring circuit 24. The second energy measuring circuit 24 provides a second measurement signal 25 representing the intensity of the acoustic source as detected by the omni-directional microphone 20. More specifically, the second energy measuring circuit 24 may integrate the magnitude of second digital audio signal 23 and the second energy measurement signal 25 may be an 8 KHz signal with each sample value representing the average magnitude of each sample of the second digital audio signal 23 over a previous time interval on the order of 0.1 seconds.

Each of the first energy measurement signal 29 and the second energy measurement signal 25 may be coupled to inputs of a compare circuit 26. The compare circuit 26 provides a direction control signal 27 which indicates the relative angular direction of the acoustic source to the reference direction 30.

Referring again to FIG. 2 in conjunction with FIG. 1, the omni-directional signal strength characteristic 31 is a function of a constant “Ko” defining the sensitivity of the omni-directional microphone 20, and a function “F(d)” of the distance between the acoustic source and the omni-directional microphone 20. Therefore, the omni-directional signal strength characteristic 31 (and the value of the second measurement signal 25) can be represented by:

Eo=Ko*F(D)

The uni-directional signal strength characteristic 21 is a function of a constant “Ku” defining the sensitivity of the uni-directional microphone 12, a function “F(d)” of the distance between the acoustic source and the uni-directional microphone 12, and a function “F(θ)” of the angular direction of the acoustic source relative to the reference direction 30. Therefore, the uni-directional signal strength characteristic 21 (and the value of the first measurement signal 29) can be represented by:

Eu=Ku*F(D)*F(θ)

From the above, a value (R) can be assigned to equal Eu/Eo such that:

R=(Ku/Ko)*F(θ).

Because Ku/Ko is a constant, the value of R is a function solely of the angular direction of the acoustic source relative to the reference direction 30. As such, the compare circuit 26 functions to divide the first measurement signal 29 by the second measurement signal 25 to generate the direction control signal 27. It should be appreciated that with proper scaling of the quotient with a constant, the quotient will approach unity when the acoustic source is located at the reference direction and will approach a maximum (theoretically infinity) when the acoustic source is located at approximately 180° relative to the reference direction 30. It should also be appreciated that the compare circuit 26 may function to divide the second measurement signal 25 by the first measurement signal 29 to generate the direction control signal. In such embodiment, the quotient would approach a minimum (theoretically zero) when the acoustic source is located at approximately 180° relative to the reference direction 30.

The digital audio signal 15 output by the first A/D converter 14 is also coupled to an input of a gain control circuit 16. The gain control circuit 16 functions to adjust the dynamic range of the digital audio signal 15 in accordance with a direction control signal 27 and provide a microphone output signal 17. More specifically, the gain control circuit 16 functions in a conventional manner to adjust the dynamic range of the digital audio signal 15 such that the microphone output signal 17 is within an appropriate dynamic range for other circuitry (not shown) to which the microphone circuit 10 is coupled. Further, the gain control circuit 16 functions to suppress (e.g. adjust the dynamic range of the digital audio signal 15 to zero such that the microphone output signal 17 is zero or otherwise equivalent to no sound detected from the acoustic source) the microphone output signal 17 if the acoustic source is not within approximately 30° of the reference direction 30. To perform the suppression, the gain control circuitry receives the direction control signal 27 and compares the direction control signal to a predetermined parameter which may be a threshold quotient value that corresponds to an acoustic source located at 30° relative to the reference direction. However, it should also be appreciated that the threshold value may be a dynamic threshold set based on historical operation of the circuit or other parameter(s) which are known to those skilled in the art.

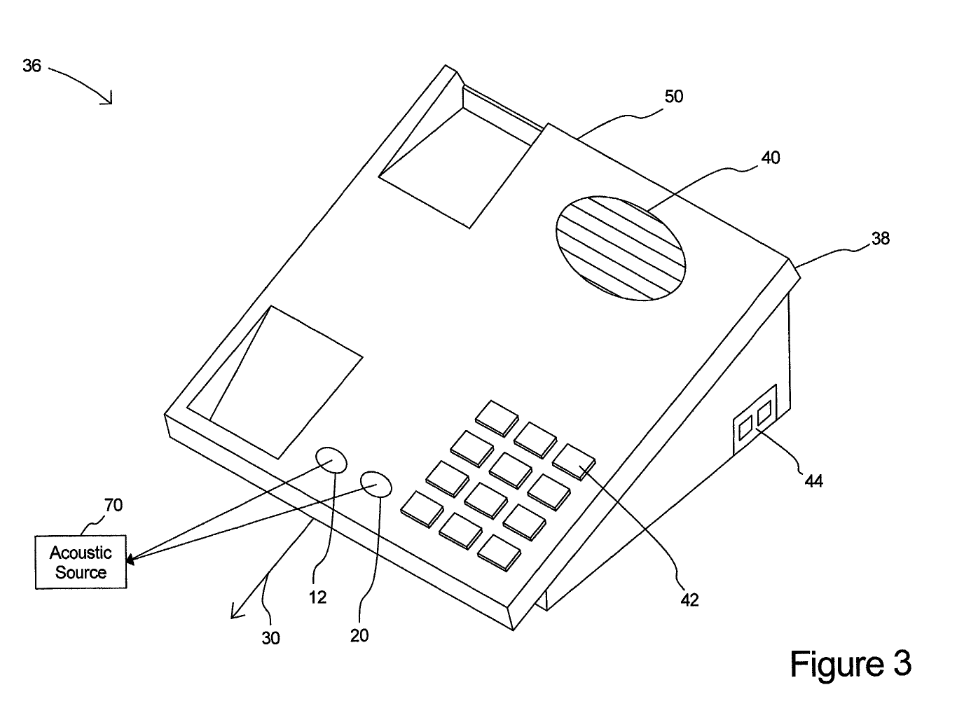

Turning to FIG. 3, a desk top speaker phone 36 embodying the microphone circuit 10 of FIG. 1 is shown. The desk top speaker phone 36 includes a housing 38 that is configured as a desk top speaker phone and functions to enclose the microphone input circuit 10 and other circuits (discussed with reference to FIG. 2) useful for the operation of the speaker phone 36. The housing 38 also supports a keypad 42 for dialing the speaker phone 36, at least one connection port 44 for coupling the speaker phone 36 to a telephone network (not shown), a loudspeaker 40, and each of the uni-directional microphone 12 and the omni-directional microphone 20 of the microphone circuit 10.

The uni-directional microphone 12 and the omni-directional microphone 20 are positioned near a front side 46 of the housing 38 in close proximity to each other such that an acoustic source 70 spaced apart form the speaker phone 36 is approximately the same distance form each of the omni-directional microphone 12 and the uni-directional microphone 20. Because the speaker phone 36 is customarily used on a flat surface with the front side 46 facing the operator, the reference direction 30 about which the cardoid polar response pattern of the uni-directional microphone 12 is centered extends from the front side 46 in a generally perpendicular direction. The loudspeaker 40 is positioned approximately 180° away from the reference direction 30 near a back side 50 of the speaker phone 36.

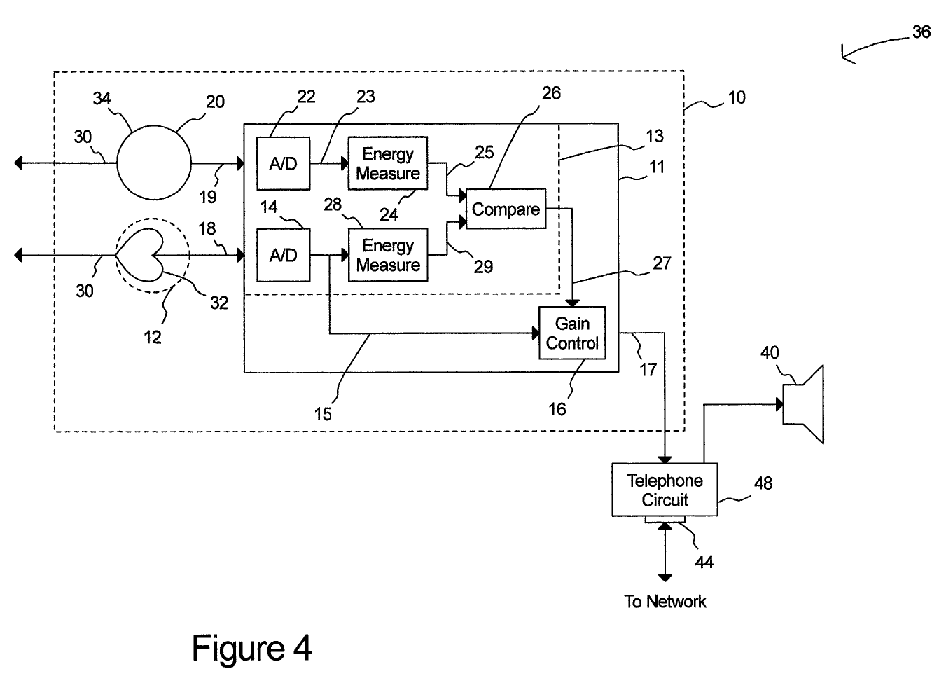

Turning to FIG. 4, a block diagram of the speaker phone 36 is shown. The speaker phone 36 includes a telephone circuit 48 for transmitting a signal representing the microphone output signal 17 to a remote telephone device and receiving an inbound audio signal stream from the remote telephone device over a telephone network through the port 44. It is envisioned that the telephone network may be any network over which the signals may be transmitted and received. Such telephone networks may include a traditional plain old telephone service (POTS) network, a digital telephone network, or a packet switched network such as a TCP/IP compliant data network. The inbound audio signal received from the remote telephone device represents the voice of the remote caller and may be converted to an appropriate signal for driving the loudspeaker 40 to generate an acoustic signal representing the inbound audio signal.

The speaker phone 36 receives the operators voice input through the microphone circuit 10 which includes each of the components discussed with reference to FIG. 1. As discussed with reference to FIG. 3, the reference direction 30 about which cardoid polar response pattern of the uni-directional microphone 12 is centered is directed towards the operator and the loudspeaker 40 is positioned approximately 180° away from the reference direction 30. As such, the dynamic range of the first digital audio signal 15 when the uni-directional microphone 12 is detecting the operators voice at (or within approximately 30° of) the reference direction 30 may be appropriately adjusted by the gain control circuit 16 such that the microphone output signal 17 represents the operators voice. However, the dynamic range of the first digital audio signal 15 when the uni-directional microphone 12 is detecting acoustic feedback from the loudspeaker 40 at (or close to) 180° from the reference direction 30 may be suppressed by the by the gain control circuit 16.

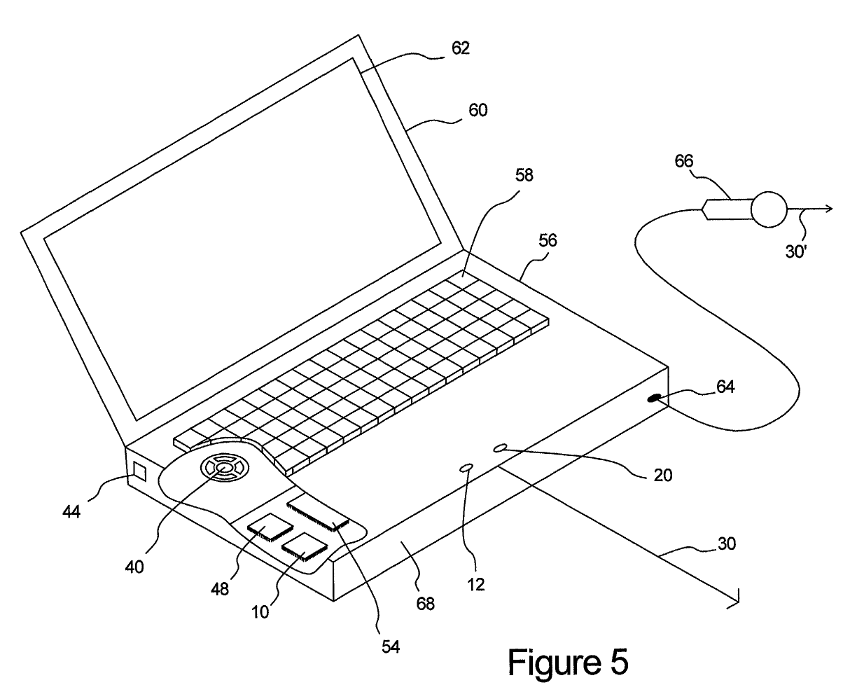

Referring to FIG. 5, a speaker phone equipped note book computer 52 is shown in partial cut away view. The note book computer 52 includes a base housing 56 that encloses a microphone circuit 10 as described with reference to FIG. 1. The note book computer 52 also includes a display housing 60 which is hinged to the base housing 56 and configured to fold over the top of the base housing 56 when not in use. A liquid crystal display screen 62 is enclosed in the display housing 60. Each of the uni-directional microphone 12 and the omni-directional microphone 20 of the microphone circuit 10 are positioned towards a front side 68 of the base housing 56 in close proximity to each other. The reference direction 30 about which the cardoid polar response pattern of the unidirectional microphone 12 is directed way from the front side 68 of the base housing 56 at a generally perpendicular angle which is generally towards the operator of the note book computer 52 when in use.

Also included within the base housing 52 is a telephone circuit 48 and a loudspeaker 40. The loudspeaker 40 is generally located at 180° from the reference direction 30. The telephone circuit 48 may have the structure and function as the telephone circuit 48 described with reference to FIG. 4.

A processor 54 may control operation of the telephone circuit 48 and the audio input circuit 10 such that a telephone audio session may be maintained with a remote telephone client.

As an alternative embodiment, the notebook computer 52 may include a microphone jack 64 to which a tethered microphone assembly 66 may be connected to the notebook computer 52.

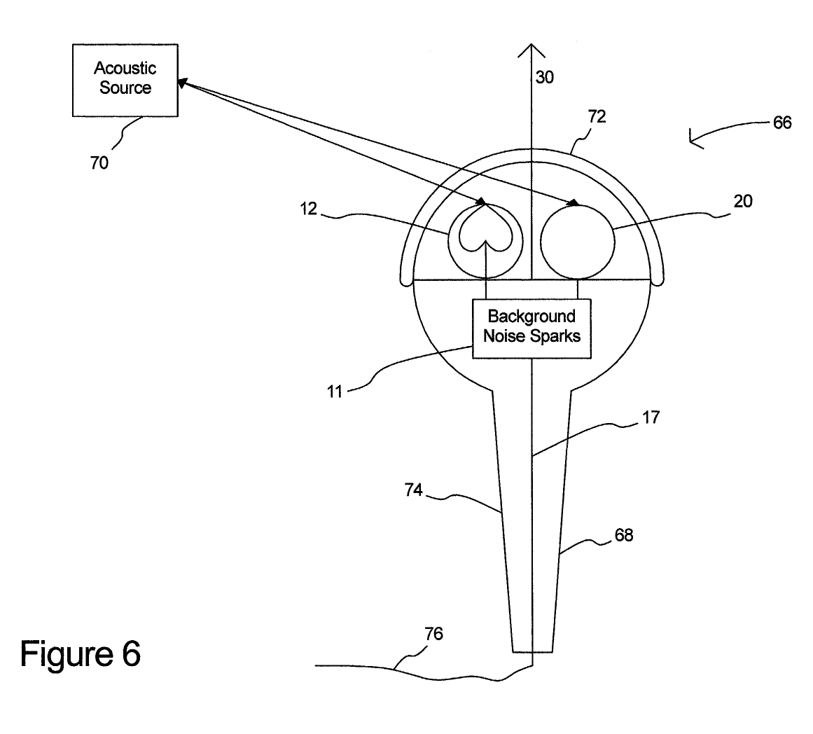

Referring to FIG. 6, the tethered microphone assembly 66 would include the microphone circuit 10 as discussed with respect to FIG. 1 enclosed in a hand held housing 68. Each of the uni-directional microphone 12 and the omni-directional microphone 20 are positioned in close proximity in a bulb portion 72 of the housing 68. Again, the uni-directional microphone 12 has a cardoid polar response pattern centered about a reference direction 30 which would extend away from a handle portion 74 of the housing 68 such that the reference direction is towards an operator holding the housing 68 by the handle portion 74 in a typical manner.

The microphone output signal 17 of the microphone circuit 10 will be coupled to a cable 76 for coupling to the notebook computer 52 (FIG. 5) or for coupling to any other device to which microphone input is desired.

Referring to FIG. 1 in conjunction with FIG. 6, it should be appreciated that the dynamic range of the first digital audio signal 15 when the uni-directional microphone 12 is detecting the operators voice at (or within approximately 30° of) the reference direction 30 may be appropriately adjusted by the gain control circuit 16 such that the microphone output signal 17 represents the operators voice. However, the dynamic range of the first digital audio signal 15 when the uni-directional microphone 12 is detecting an acoustic source outside of approximately 30° of the reference direction (such as towards the handle portion 74) may be suppressed by the by the gain control circuit 16. Therefore, the microphone output signal 17 coupled to the cable 76 will include suppression of sources outside of approximately 30° of the reference angle. As such, the note book computer 52 of FIG. 5 (or other device to which the tethered microphone 66 is coupled) will not need to include the microphone circuit 10. An example for a use for a tethered microphone 66 would be an operator speaking into the tethered microphone 66 on a stage. The operator's voice will be an acoustic source that is not suppressed while background noise from the audience will be suppressed.

In summary, the systems and methods of this invention provides for filtering acoustic feed back from a loudspeaker at the microphone input system for a full duplex speaker phone. Although the invention has been shown and described with respect to certain preferred embodiments, it is obvious that equivalents and modifications will occur to others skilled in the art upon the reading and understanding of the specification. For example, the exemplary embodiments of a uni-directional microphone discussed in the specification include a cardoid polar response pattern, however those skilled in the art will recognize that other non-circular response patterns may as will suffice. The present invention includes all such equivalents and modifications, and is limited only by the scope of the following claims.

What is claimed is:

1. A circuit for determining the angular direction of an acoustic source relative to a reference direction, the circuit comprising:
a) a uni-directional microphone providing a uni-directional output signal representing the acoustic source, the uni-directional output signal having a signal strength characteristic that is a function of the angular position of the acoustic source relative to the reference direction;
b) a omni-directional microphone providing an omni-directional output signal representing the acoustic source, the omni-directional output signal having a signal strength characteristic that is substantially independent of the angular position of the acoustic source relative to the reference direction; and
c) a directional calculation circuit for determining the angular position of the acoustic source relative to the reference direction utilizing the difference between the signal strength characteristic of the uni-directional output signal and the signal strength characteristic of the omni-directional output signal.

2. The circuit for determining the angular direction of an acoustic source relative to a reference direction of claim 1, wherein:
a) both the signal strength characteristic of the uni-directional output signal and the signal strength characteristic of the omni-directional output signal are further a function of the loudness of the acoustic source and the distance between the acoustic source and each of the uni-directional microphone and the omni-directional microphone; and
b) wherein the directional calculation circuit calculates a quotient between the signal strength characteristic of the uni-directional output signal and the signal strength characteristic of the omni-directional output signal to determined the angular position of the acoustic source relative to the reference signal.

3. The circuit for determining the angular direction of an acoustic source relative to a reference direction of claim 2, wherein the uni-directional microphone is located in close proximity to the omni-directional microphone whereby both the uni-directional microphone and the omni-directional microphone are approximately the same distance from the acoustic source.

4. The circuit for determining the angular direction of an acoustic source relative to a reference direction of claim 1, wherein the uni-directional microphone is located in close proximity to the omni-directional microphone whereby both the uni-directional microphone and the omni-directional microphone are approximately the same distance from the acoustic source.

5. A microphone assembly comprising:
a) a uni-directional microphone for receiving acoustic input from an acoustic source and for generating a uni-directional output signal, the uni-directional output signal having a signal strength characteristic that is a function of the angular direction of the acoustic source relative to a reference direction, the function having a maxima when the acoustic source is located at the reference direction;
b) a omni-directional microphone for receiving acoustic input from the acoustic source and for generating an omni-directional output signal, the omni-directional output signal having a signal strength characteristic that is substantially independent of the angular direction of the acoustic source relative to the reference direction; and
c) a background noise suppression circuit for receiving the uni-directional output signal and the omni-directional output signal and for generating a microphone output signal, the background noise suppression circuit comprising:
i) a directional calculation circuit for determining a difference between the signal strength characteristic of the uni-directional output signal and the signal strength characteristic of the omni-directional output signal; and
ii) a gain control circuit for suppressing the microphone output signal if the difference between the signal strength characteristic of the uni-directional output signal and the signal strength characteristic of the omni-directional output signal is not within a predetermined parameter.

6. The microphone assembly of claim 5, wherein:
a) both the signal strength characteristic of the uni-directional output signal and the signal strength characteristic of the omni-directional output signal are further a function of the loudness of the acoustic source and the distance between the acoustic source and each of the uni-directional microphone and the omni-directional microphone;
b) wherein the function of determining a difference between the signal strength characteristic of the uni-directional output signal and the signal strength characteristic of the omni-directional output signal includes calculating a quotient between the signal strength characteristic of the uni-directional output signal and the signal strength characteristic of the omni-directional output signal; and
c) wherein the function of suppressing the microphone output signal if the difference between the signal strength characteristic of the uni-directional output signal and the signal strength characteristic of the omni-directional output signal is not within a predetermined parameter includes suppressing the microphone output signal if the quotient is not within a threshold value of unity.

7. The microphone assembly of claim 6, wherein the uni-directional microphone is located in close proximity to the omni-directional microphone whereby both the uni-directional microphone and the omni-directional microphone and both the uni-directional microphone and the omni-directional microphone are approximately the same distance from the loudspeaker.

8. The microphone assembly of claim 5, wherein the uni-directional microphone is located in close proximity to the omni-directional microphone whereby both the uni-directional microphone and the omni-directional microphone and both the uni-directional microphone and the omni-directional microphone are approximately the same distance from the loudspeaker.

9. A full duplex speaker phone comprising:
a) a uni-directional microphone for receiving acoustic input from an acoustic source and for generating a uni-directional output signal, the uni-directional output signal having a signal strength characteristic that is a function of the angular direction of the acoustic source relative to a reference direction, the function having a maxima when the acoustic source is located at the reference direction;
b) a omni-directional microphone for receiving acoustic input from the acoustic source and for generating a omni-directional output signal, the omni-directional output signal having a signal strength characteristic that is substantially independent of the angular direction of the acoustic source relative to the reference direction;
c) a background noise suppression circuit for receiving the uni-directional microphone signal and the omni-directional microphone signal and for generating an output audio signal, the background noise suppression circuit comprising:
i) a directional calculation circuit for determining a difference between the signal strength characteristic of the uni-directional output signal and the signal strength characteristic of the omni-directional output signal; and
ii) a gain control circuit for suppressing the microphone output signal if the difference between the signal strength characteristic of the uni-directional output signal and the signal strength characteristic of the omni-directional output signal is not within a predetermined parameter;
d) a telephone circuit for transmitting a representation of the microphone output signal to a remote telephone device and receiving an inbound audio signal from the remote telephone device; and
e) a loudspeaker coupled to the telephone circuit for generating an acoustic signal representing the inbound audio signal received from the remote telephone device, the loudspeaker being located approximately 180 degrees from the reference direction.

10. The full duplex speaker phone of claim 9, wherein:
a) both the signal strength characteristic of the uni-directional output signal and the signal strength characteristic of the omni-directional output signal are further a function of the loudness of the acoustic source and the distance between the acoustic source and each of the uni-directional microphone and the omni-directional microphone;
b) wherein the function of determining a difference between the signal strength characteristic of the uni-directional output signal and the signal strength characteristic of the omni-directional output signal includes calculating a quotient between the signal strength characteristic of the uni-directional output signal and the signal strength characteristic of the omni-directional output signal; and
c) wherein the function of suppressing the microphone output signal if the difference between the signal strength characteristic of the uni-directional output signal and the signal strength characteristic of the omni-directional output signal is not within a predetermined parameter includes suppressing the microphone output signal if the quotient is not within a threshold value of unity.

11. The full duplex speaker phone of claim 10, wherein the uni-directional microphone is located in close proximity to the omni-directional microphone whereby both the uni-directional microphone and the omni-directional microphone and both the uni-directional microphone and the omni-directional microphone are approximately the same distance from the loudspeaker.

12. The full duplex speaker phone of claim 9, wherein the uni-directional microphone is located in close proximity to the omni-directional microphone whereby both the uni-directional microphone and the omni-directional microphone and both the uni-directional microphone and the omni-directional microphone are approximately the same distance from the loudspeaker.

13. The full duplex speaker phone of claim 9, further including a housing configured as a desk top telephone and wherein the uni-directional microphone and the omni-directional microphone are located near the front side of the housing, the loudspeaker is located near a back side of the housing, and the reference direction is generally extends from the front of the housing.

14. The full duplex speaker phone of claim 9, further including a housing configured as a note book computer, and wherein the uni-directional microphone and the omni-directional microphone are located near a front side of a base housing portion of the note book computer and the loudspeaker is located in a base housing portion of the note book computer behind the uni-directional microphone and the omni-directional microphone.

15. A method for determining the angular direction of an acoustic source relative to a reference direction, the method comprising:
a) detecting the acoustic source at a uni-directional microphone and providing a uni-directional output signal representing the intensity of the acoustic source, the distance of the acoustic source from the uni-directional microphone, and the angular direction of the acoustic source relative to a reference direction from the uni-directional microphone;
b) detecting the acoustic source at a omni-directional microphone and providing a omni-directional output signal representing the intensity of the acoustic source and the distance of the acoustic source from the omni-directional microphone; and
c) calculating the angular direction of the acoustic source relative to the reference direction by comparing the uni-directional output signal to the omni-directional output signal.

16. The method for determining the angular direction of an acoustic source relative to a reference direction of claim 15, wherein the step of calculating the angular direction of the acoustic source relative to the reference direction includes calculating the quotient between a signal strength characteristic of the uni-directional output signal and a signal strength characteristic of the omni-directional output signal.

17. The method for determining the angular direction of an acoustic source relative to a reference direction of claim 16, wherein the step of detecting the acoustic source at the uni-directional microphone is performed in close proximity to the step of detecting the acoustic source at the omni-directional microphone whereby both steps are performed at approximately the same distance from the acoustic source.

18. The method for determining the angular direction of an acoustic source relative to a reference direction of claim 15, wherein the step of detecting the acoustic source at the uni-directional microphone is performed in close proximity to the step of detecting the acoustic source at the omni-directional microphone whereby both steps are performed at approximately the same distance from the acoustic source.
